(19) United States
(12) Patent Application Publication
(10) Pub. No.: US 2012/0050351 A1
(43) Pub. Date: Mar. 1, 2012

(54) Method for operating a projector having a high-pressure discharge lamp

(75) Inventors: Bastian Dobler, Unterhaching (DE); Andreas Huber, Maisach (DE); Josef Kroell, Potsdam (DE); Oskar Schallmoser, Ottobrunn (DE)

(73) Assignee: OSRAM AG, Muenchen (DE)

(21) Appl. No.: 13/319,522

(22) PCT Filed: May 15, 2009
(86) PCT No.: PCT/EP09/55898

§ 371 Date: Nov. 9, 2011

(51) Int. Cl. G09G 5/10; G03B 21/20

(52) U.S. Cl. 345/690; 353/85

(57) ABSTRACT

In various embodiments, a method for operating a projector having a high-pressure discharge lamp, wherein an intensity of a light emitted by the high-pressure discharge lamp depends upon an electrical power supplied to the high-pressure discharge lamp, may comprise providing image information to be projected and, depending on the image information, determining a nominal value for the intensity of the light, supplying electrical power to the high-pressure discharge lamp at least in dependence on the nominal value for the intensity, determining a value correlated with a temperature of the high-pressure discharge lamp, and supplying additional electrical power-depending on the value for the temperature.

### TECHNICAL FIELD

The invention relates to methods for operating a projector having a high-pressure discharge lamp, wherein the projector can project image information and wherein, for a projection, light is emitted by the high-pressure discharge lamp and hereby an intensity of the light depends upon an electrical power supplied to the high-pressure discharge lamp. The invention also relates to a projector with a control unit.

### PRIOR ART

A projector enables an image or a sequence of images to be displayed on a projection surface. To display an image, frequently a liquid crystal display (LCD) in the interior of the projector is used to generate the image in a small format from image information. The liquid crystal display is hereby transilluminated by means of a light source. The light modulated by the liquid crystal display according to the image information is projected through an optical system onto the projection surface, for example a screen. Instead of a liquid crystal display, it is also possible, for example, to use a digital micromirror device (DMD, DLP®—Digital Light Processing®).

One important property for the projection of an image is its brightness. This should be understood to mean a mean brightness value obtained from the values for the brightness of the individual pixels of the image.

Hereby, in order to project a relatively dark image by means of a projector, it is necessary, for example with a liquid crystal display, to block a significant part of the light emitted by the light source with the liquid crystal display in order to obtain a correspondingly dark region on the projection surface. However, liquid crystal displays and similar display elements to generate an image in small format are hereby often not able to suppress the luminous flux of the light source sufficiently enough to ensure that, in a black image region, no light is actually also projected onto the projection surface. Instead, a region of this kind appears gray to an observer due to the residual light passing through the liquid crystal display element. The situation is similar with digital micromirror devices.

Due to the residual light, with an image, which is relatively dark overall, the projection of said image has a different relationship between the brightness of the brightest region of the image and that of the darkest region of the image than is the case with the actual image. The relationship between the intensity values for the brightness of the brightest and the darkest image regions is referred to as the contrast of an image. Correspondingly, a deterioration of the contrast is spoken of if the contrast is reduced due to the residual light during the projection of dark images.

U.S. Pat. No. 5,717,422 A describes a projector with which the luminous intensity of a light source is varied as a function of the image information. Hereby, to display a relatively dark image, the intensity of the light emitted by the light source is reduced. The simultaneous variation of a contrast of an image generated in a transparent display results in the generation of a projection of the image with an improved contrast.

High-pressure discharge lamps are frequently used as light sources for projectors. This type of gas discharge lamp is also known as a HID lamp (HID—high intensity discharge). These are able to emit light with particularly high intensity. Hereby, the intensity of light describes the radiation energy emitted by the lamp per time unit into a specific solid angle element by the lamp.

During the operation of a high-pressure discharge lamp, the temperature of the high-pressure discharge lamp has to lie within a relatively narrow temperature range. Depending upon the type of high-pressure discharge lamp, the optimum operating temperature can be, for example, approximately 900° Celsius; any deviation therefrom may then, for example, be maximum 100° Celsius toward higher or lower temperatures. If a high-pressure discharge lamp is operated at too low a temperature, undesirable blackening of the lamp takes place. Operation at too high a temperature can destroy the high-pressure discharge lamp.

With a high-pressure discharge lamp, the intensity of the emitted light can be changed to adapt the contrast by regulating the current intensity of a current guided through the high-pressure discharge lamp. With a constant operating voltage, this changes the electrical power supplied to the high-pressure discharge lamp which is emitted in the form of light. However, electrical power cannot be reduced at will to improve the contrast in the case of dark images. If too little electrical power is supplied to a high-pressure discharge lamp, it cools down. The minimum temperature required for the operation of the high-pressure discharge lamp is then fallen below and hence the lamp is damaged.

Therefore, with present-day projectors with high-pressure discharge lamps, to display dark images, the electrical power is only reduced to the extent that the lamp is operated with approximately 75% of a nominal power. Hereby, operation at nominal power results in the lamp heating up to its optimum operating temperature. Operation at approximately 75% of the nominal power then results in the lamp cooling down to a still permissible minimum temperature. To protect the lamp during operation at reduced power, it is known to reduce active cooling of the lamp, such as is effected, for example, by a blower. However, this also causes, for example, the liquid crystal display of the projector to heat up in an undesirable manner.

### SUMMARY OF THE INVENTION

It is the object of the present invention, to improve the contrast of projected images perceived by a user in a projector with a high-pressure discharge lamp, in particular during the projection of a film. Hereby, the high-pressure discharge lamp is to be operated gently and there should be no significant impairment of its lifetime.

The object is achieved by the method according to claims 1, 7 and 8 and by the projectors according to claims 13, 14 and 15.

Advantageous embodiments of the invention are disclosed in the subclaims.

A first aspect of the invention relates to a method for operating a projector with a high-pressure discharge lamp, wherein, with the projector, an intensity of a light emitted by the high-pressure discharge lamp depends upon an electrical power supplied to the high-pressure discharge lamp. With the method, image information to be projected is provided and a nominal value for the intensity of the light is determined according to the image information. Hereby, electrical power is supplied to the high-pressure discharge lamp at least in dependence on the nominal value for the intensity. The method also include the steps of determining a value, which correlates with a temperature of the high-pressure discharge lamp, and of supplying the electrical power additionally in dependence on the value for the temperature.

A value, which is correlated with a temperature of the high-pressure discharge lamp, can hereby be an actually measured temperature value or also an indirectly determined value, from which a conclusion regarding the temperature of the high-pressure discharge lamp can be drawn.

The direct determination of the temperature is possible by means of suitable sensors, which are known per se from the prior art. An indirect value can be a calculated value, such as can be calculated from a simulation of a temperature profile or with the aid of a model of the temperature profile. However, it can also be an analog voltage value, which is formed for example with the aid of a circuit, for example an RC element.

Hereby, a value that correlates with the temperature should not be understood to be a correlation in the mathematically exact sense. Neither is it necessary to be able to determine the temperature exactly with reference to the value. Depending upon the embodiment of the invention, it can be sufficient if the value may be used solely to identify whether there is a risk of damage to the lamp due to a temperature that is too high or too low. For example, it is also possible to calculate a value for a temperature by determining from the nominal value for the intensity and a period, for which this nominal value is present, a value for the resultant possible heating of the high-pressure discharge lamp.

The method according to the invention has the advantage that, with a projector, undercooling or overheating of the lamp is automatically prevented in an inexpensive way. Possible damage to the lamp is automatically prevented in that the electrical power supplied to the lamp is made dependent on the temperature. The power supplied enables the temperature of the lamp to be controlled simply, very reliably and by means of inexpensive devices.

The invention is hereby based on the knowledge that an observer often only clearly perceives a high contrast of an individual image if a previously projected image had a different brightness than the image in question. In particular in the case of a film, a change of this kind can occur frequently. With the method according to the invention, it is possible, for example on a change from a bright image to a dark image, to reduce the power for the high-pressure discharge lamp way below the value permitted for long-term operation. This enables particularly good contrast to be obtained. With the method according to the invention, this ensures that the lamp nevertheless does not cool down excessively. The control of the electrical power in dependence on the temperature protects the lamp. However, due to the time constants for the temperature profile of a high-pressure discharge lamp, this control does not take place immediately after a change to the electrical power supplied. Therefore, it is possible, in particular on a change between two images with different mean brightness levels, to adapt the luminous intensity of the lamp of the projector in such a way that the new image is displayed with a desired, high contrast.

In a development of the method according to the invention, more electrical power is supplied than that obtained according to the nominal value for the intensity if the value for the temperature is lower than a prespecified minimum value and/or less electrical power is supplied than that obtained according to the nominal value for the intensity if the value for the temperature is higher than a prespecified maximum value.

This has the advantage the presettable minimum and maximum values enable the method to be adapted in a simple way for a high-pressure discharge lamp that is to be protected against undercooling or overheating.

A further embodiment of the method according to the invention consists in the fact that the value for the temperature is calculated from power values each of which corresponds to an electrical power supplied to the high-pressure discharge lamp at a preceding time point. In other words, the electrical energy, which was supplied to the lamp in a period prior to a specific time point, is used as the basis for concluding how hot the lamp is. This has the advantage that the value for the temperature of the lamp can be determined inexpensively without an additional measuring system.

The value for the temperature is hereby preferably calculated from the power values by smoothing or filtering with a low-pass filter. This advantageously simulates the profile of the temperature of a high-pressure discharge lamp with a known power supply particularly reliably.

With a further embodiment of the method according to the invention, the amount of power supplied is changed within a prespecified period by at the most a presettable value, wherein preferably the changing is performed at least for a part of the prespecified period according to a ramp function or in a plurality of steps.

This has the advantage that an increase in an electrical voltage released via the high-pressure discharge lamp is avoided. A change in the voltage of this kind occurs in particular if the supplied electrical power is reduced too quickly by a specific measurable amount. The electrical power is reduced too quickly if the temperature of the electrodes and of the gas in the lamp is unable to follow the change in the power quickly enough.

The invention also includes a projector having a high-pressure discharge lamp and a control unit, which is designed to accept a nominal value for an intensity of a light emitted by the high-pressure discharge lamp and to supply electrical power to the high-pressure discharge lamp at least in dependence on the nominal value.

The control unit is designed to determine a value corresponding to a temperature of the high-pressure discharge lamp and additionally to supply electrical power to the high-pressure discharge lamp in dependence on the value for the temperature.

The projector according to the invention has the same advantages as those with the method according to the invention. It is obviously possible further to develop the projector according to the invention in accordance with the method according to the invention, which also results in the corresponding advantages with the developed projector.

With the method and the projector, it can also be provided that additionally a cooling device, that is, for example, a fan, is controlled in such a way, for example in dependence on the determined value for the temperature, that undercooling or overheating of the high-pressure discharge lamp is counteracted.

In addition, it can obviously be provided that a transparent or a reflecting display element of the projector, that is for example an LCD display or micromirror device, is controlled in such a way according to the supplied power that a desired improved contrast of a projected image results.

A second aspect of the invention relates to a method for operating a projector with a high-pressure discharge lamp, wherein, as in the case of the method described above, with the projector, an intensity of a light emitted by the high-pressure discharge lamp depends upon an electrical power supplied to the high-pressure discharge lamp.

With the method according to the second aspect, once again image information to be projected is provided, in dependence on the image information, a nominal value for the intensity of the light is determined and electrical power is supplied to the high-pressure discharge lamp at least in dependence on the nominal value for the intensity.

In addition, a mean value is calculated for an electrical power supplied to the high-pressure discharge lamp in a preceding time interval and additionally the electrical power is supplied in dependence on the calculated mean value in accordance with a controller for adjusting the mean value to a nominal mean value.

This method advantageously prevents any lengthy deviation of the temperature of the high-pressure discharge lamp from an optimum operating temperature. This achieves a particularly gentle operation of the lamp. Hereby, it is possible in a simple way, for example by specifying suitable time constants for the controller, to ensure that the supplied electrical power can be adapted to improve the contrast of a projected image for a short period, i.e. in particular on a change between images with different brightness levels.

The invention also includes a projector of the type mentioned above with a high-pressure discharge lamp and a control unit, with which, unlike the projector already described or in addition thereto, the control unit is designed to calculate a mean value for an electrical power supplied to the high-pressure discharge lamp in a preceding time interval and additionally to supply the electrical power in dependence on the calculated mean value in accordance with a controller for adjusting the mean value to a nominal mean value.

This projector makes the method described particularly simple to implement. The same advantages are obtained as with the method. The projector can also be further embodied according to the further developments of the method.

The method and the projector according to the second aspect of the invention can also obviously be further developed in such a way that the controller of the mean power can also be used to control a cooling device in order to adjust a mean temperature of the lamp by means of the cooling device.

In exactly the same way, it can be provided that a display element of the projector is controlled in such a way that a change in the contrast of a projected image is counteracted if the controller changes the power supplied to the lamp.

A third aspect of the invention relates to a method for operating a projector with a high-pressure discharge lamp of the type mentioned above. With the method, as in the above case, image information to be projected is provided, a nominal value for the intensity of the light is determined in dependence on the image information and electrical power is supplied to the high-pressure discharge lamp at least in dependence on the nominal value for the intensity.

With the method according to the third aspect, a future nominal value for an intensity to be provided at a prespecified future time point is determined. Hereby, prior to this future time point, a temperature of the high-pressure discharge lamp changes in dependence on the future nominal value. This has the advantage that the lamp can be operated for a longer period to improve the contrast at a power value which is per se critical for a gentle operation of the lamp. This method is further developed in an advantageous way if a) the nominal value determined for the intensity is a future nominal value or b) a future nominal value is estimated by means of a statistical evaluation of consecutive nominal values for the intensity.

Case a) has the advantage that the future time point of a change to the power is known precisely. Case b) has the advantage that the future nominal value can also be determined even if it is not possible to take the image information to be projected in the future from a source for the image information, for example a DVD player (DVD—Digital Versatile Disc, Digital Video Disc).

In a further embodiment of the method, the temperature is increased if the future nominal value falls below a presettable first threshold value and/or the temperature is reduced if the future threshold value falls below a presettable second threshold value.

In other words, the high-pressure discharge lamp is preheated or precooled in an advantageous way if it is recognized that, at a future time point, the lamp is to be supplied with particularly low or particularly high electrical power.

To change the temperature prior to the future time point, in an advantageous further development of the method, power is additionally supplied to the high-pressure discharge lamp power in dependence on the future nominal value, wherein the light transmission or reflectance behavior of a transparent or a reflecting display element of the projector, by means of which image information can be displayed and which is transilluminated or illuminated for the projection of image information to be projected with the light of the high-pressure discharge lamp, is changed in dependence on the future nominal value.

This advantageously represents a particularly inexpensive possibility of controlling the temperature of the lamp without this resulting in an impairment of the contrast of the images projected prior to the future time point.

In an alternative further development of the method, the temperature is changed by changing a cooling capacity of a cooling device for the high-pressure discharge lamp. A cooling device of this kind, can, for example, be a blower or a fan in the projector. This further development of the method has the advantage that the temperature can be changed using cooling devices such as those already present in numerous projectors from the prior art. This makes the implementation of the method particularly inexpensive.

The method can in an advantageous way be particularly simply implemented on a projector according to the invention including a high-pressure discharge lamp and a control unit similar to the one already described in connection with the method according to the previous aspects of the invention. However, according to the third aspect of the invention, the control unit is in particular designed to determine a future nominal value for an intensity to be provided at a prespecified future time point and, prior to the future time point, to change a temperature of the high-pressure discharge lamp in dependence on the future nominal value. Once again, this projector can obviously be further developed according to the different embodiments which will result in the corresponding advantages.

The control units of the projectors according to the three aspects of the invention may also be present jointly in the form of a single control unit providing the functionalities of two of the three or all three control units. The control units are hereby each or all together preferably embodied as part of an electronic ballast.

Finally, it is obviously also possible within the scope of the invention to combine features of the invention such as those resulting from the three different aspects of the invention.

### BRIEF DESCRIPTION OF THE DRAWINGS

In the following, the invention will be explained in more details with reference to exemplary embodiments; the figures show:

FIG. 1 a block diagram of a control unit for setting a luminous intensity of a high-pressure discharge lamp of a projector for film projections according to an embodiment of a projector according to the invention;

FIG. 2 a diagram with graphs of temporal profiles of parameters such as those resulting from an embodiment of the method according to the invention, which is performed in the control unit, explained in connection with FIG. 1;

FIG. 3 a diagram on the profile of a temperature, such as that which occurs with a high-pressure discharge lamp, which is preheated according to one embodiment of the method according to the invention; and

FIG. 4 a diagram in accordance with the diagram in FIG. 3, wherein a high-pressure discharge lamp is precooled according to one embodiment of the method according to the invention.

### PREFERRED EMBODIMENTS OF THE INVENTION

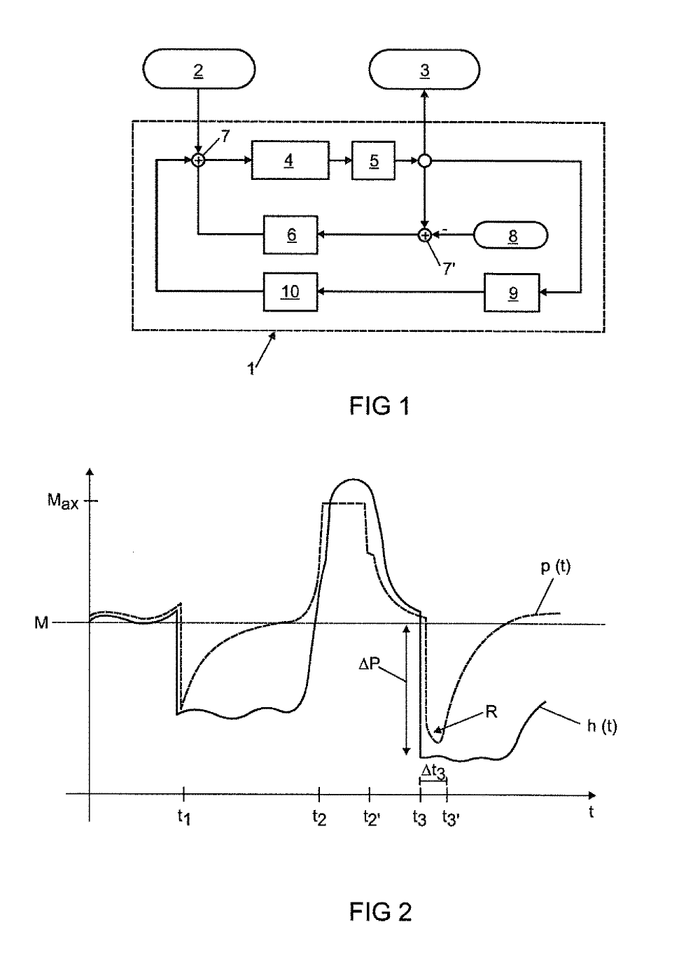

FIG. 1 shows a block diagram describing a mode of operation of a control unit 1, with which, in a projector (not further shown in FIG. 1), an electrical power for operating a high-pressure discharge lamp of the projector is adjusted. The control unit 1 can be a component of an electronic ballast for the high-pressure discharge lamp via which the adjusted electrical power is supplied to the high-pressure discharge lamp. The fact that, during operation of the high-pressure discharge lamp, the electrical power supplied changes causes a corresponding change in the intensity of the light emitted by the high-pressure discharge lamp, i.e. in other words, the luminous intensity of the high-pressure discharge lamp.

The projector may project a single image or a sequence of images, for example of a film, onto a wall. The projector receives the corresponding image information from an image source (not shown in FIG. 1), such as, for example, a computer or a DVD player. To generate the projection, the projector can have a built-in liquid crystal display or a comparable transparent display with which a light intensity or a light color of the light shining through the display of the high-pressure discharge lamp can be changed for individual pixels. The display may also be provided by a light-reflecting micromirror device instead of a transparent display with which a reflection property can be determined by changing the position of individual micromirrors.

The control unit 1 may be used to change the luminous intensity of the high-pressure discharge lamp in such a way that, for the projection of an overall dark image, the luminous intensity is reduced. This may improve the contrast of the projection of the image. The luminous intensity may also be increased if an image with relatively bright colors is to be displayed.

To adjust the luminous intensity of the high-pressure discharge lamp, in the projector, a value for the mean brightness of an image and value for the contrast of the image is calculated from an image to be projected. These two values may be used to determine a value for the luminous intensity of the lamp with which the image can be optimally projected with respect to the contrast of a projection of the image. The value for the luminous intensity calculated in this way represents a nominal value 2 for the luminous intensity, which is transmitted to the control unit 1. It is also possible for the nominal value 2 to be calculated by the control unit 1 itself.

In the block diagram in FIG. 1, prespecified or calculated values are symbolized by fields with rounded edges.

The control unit 1 uses the nominal value 2 for the luminous intensity to calculate a power value 3 by which power electronics (not shown in FIG. 1) of the electronic ballast of the projector are controlled. The power electronics then supply the high-pressure discharge lamp with an electrical power corresponding to the power value. To prevent a power values which is too high or too low for the operation of the ballast or the high-pressure discharge lamp being output, a limiting unit 4 ensures that only values lying between a minimum value and a maximum value are output as the power value 3.

In addition, a rate limiter 5 for limiting the rate of change of the power value prevents the power value within a prespecified period from being able to fall to smaller values by more than a prespecified amount. This means that it is not possible for there to be an increase in a voltage through the high-pressure discharge lamp due to an over-rapid reduction in the power supplied. This prevents a unit for estimating a degree of wear of the lamp from determining an incorrect value. In addition, this prevents damage to the projector in the event of very high sudden voltage changes.

The mode of operation of the rate limiter 5 will be explained in more detail below.

The power value 3 is not only a function of the nominal value 2 for the luminous intensity. The control unit 1 also ensures by regulating the power value 3 that the high-pressure discharge lamp is operated gently.

To this end, an integrator 6 determines a correction value which is linked by means of a linking device 7 to the nominal value 2 for the luminous intensity. Hereby, the correction value ensures that, in an ideal case, the electrical power controlled by the power value 3 supplied to the high-pressure discharge lamp has a mean value corresponding to a prespecified nominal mean value. To this end, the mean value of the power value 3 is adjusted by means of the integrator 6 to a nominal mean value 8. Expressed as a mathematical equation, the following applies in the ideal case:

$$\frac{1}{T} {\int }_{- T}^{0} p ( t + τ ) d τ = {P}_{soll} ,$$

where p(t) is the power value 3 at the time point t, T is a presettable period for the calculation of the mean value and Pₛₒₗₗ is the nominal mean value 8.

In the control unit 1, for the adjustment of the power value 3 to the nominal mean value 8, a second linking device 7′ calculates a deviation of the current power value 3 from the nominal mean value 8 as a differential value and this differential value is transmitted to the integrator 6. From this, the integrator 6 calculates the correction value according to the rules for an integral controller (I controller) or a proportional integral-controller (PI controller) or a comparable controller. The correction value is then applied by the linking device 7 to the nominal value 2. The linking devices 7 and 7′ may, for example, be adders, wherein optionally, by weighting one of the inputs of an adder of this kind with a proportionality factor, it is also possible to calculate differences. Linking devices with other links, such as, for example, a multiplication or a division, are also possible.

In order to explain the influence of the correction value on the control of the power value 3, FIG. 2 shows a diagram in which a graph p(t) is formed from a sequence of power values 3 at different time points t. In the diagram in FIG. 2, a graph h(t) is also formed from a sequence of nominal values 2, which are transmitted at the corresponding time points t to the control unit 1. Finally, a mean value line M is plotted in the diagram.

The graphs p(t) and h(t) are scaled differently with respect to the ordinate axis and stacked such that the mean value line M serves as an orientation line for both graphs p(t) and h(t). With respect to the graph h(t), the mean value line M represents a nominal value 2, such as is obtained for an image with a mean brightness. With respect to the graph p(t), the mean value line M represents the power value 3 at which an optimum operating temperature is obtained for the high-pressure discharge lamp. The electrical power supplied to the high-pressure discharge lamp hereby is known as the nominal power.

The graphs p(t) and h(t) are obtained from sequences of corresponding values such as those that occur with a projection of a sequence of images of a film with the projector, which was explained above in connection with FIG. 1. Since a nominal value 2 is calculated for every individual image of the films and accordingly a power value 3 is output, in this example 25 nominal values per second are transmitted to the control unit 1 and 25 power values determined thereby. In the diagram in FIG. 2, the individual consecutive values are connected to form lines.

At a time point t₁, a scene change takes place in the film displayed by means of the projector. This causes a change in the brightness of the projected images. The images for the scene, which are projected immediately after the time point t₁, are significantly darker than images with a mean brightness. Therefore, the nominal value 2 is reduced accordingly so that, at the time point t₁, the graph h(t) jumps to smaller values. Accordingly, the power value 3 is also reduced in order to be able to project even the darker images with a desired contrast. At the time point t₁, the graph p(t) therefore jumps to smaller values like the graph h(t). The electronic ballast of the projector supplies correspondingly less electrical power to the high-pressure discharge lamp so that the luminous intensity of the high-pressure discharge lamp drops in the desired manner. At the same time, with the display unit of the projector described in connection with FIG. 1, the contrast of each image displayed is adapted to the reduced luminous intensity.

In this example, during the projection of dark images, the electrical power supplied drops to 20 percent of the nominal power. An observer of the projected sequence of images perceives in the desired way the transition between scenes due to the great reduction in the image brightness on the scene change at the time point t₁ as particularly significant.

The power value 3 emitted by the control unit 1 at the time point t₁ is too low to be retained for a longer time. This would result in a cooling of the high-pressure discharge lamp to below a minimum value for a temperature of the high-pressure discharge lamp. This would cause permanent damage to the lamp.

The control by means of the integrator 6 ensures that, during a time interval between the time points t₁ and t₂, the power value 3 is not maintained at such low values as would actually be obtained according to the profile the nominal values 2 for the luminous intensity according to the graph h(t) between the time points t₁ and t₂. Instead, following the scene change at the time point t₁, the power value is raised again to the value represented by the mean value line M. This prevents the high-pressure discharge lamp from cooling to below a minimum temperature. This increase in the power value 3 is effected by the correction value, which is issued by the integrator 6 and added via the linking device 7 to the low value 2.

An observer scarcely perceives the increase in the luminous intensity of the high-pressure discharge lamp after the scene change at the time point t₁.

A second scene change at the time point t₂ results in a sequence of relatively bright images. Accordingly, the nominal value 2 for the luminous intensity increases, which is also recognizable on the corresponding profile of the graphs h(t) between the time points t₂ and t₃. The power value 3 is also raised by the nominal power value represented by the mean value line M in order to obtain correspondingly bright projections of the images.

However, the power value 3 is not raised as high as would be the case according to the nominal value 2 immediately after the time point t₂. The power value 3 is limited by the limiting unit 4 to a maximum permissible maximum value Max.

Since, to display the scene during the time interval between the time points t₂ and t₃, the maximal permissible power is supplied to the high-pressure discharge lamp, at a time point t₂′, the lamp heats up to a maximum permissible temperature.

This is identified by a temperature sensor 9 shown in FIG. 1, which is also a component of the control unit 1. In the present example, the temperature sensor 9 determines a temperature of the lamp to be monitored with reference to the power value 3.

To this end, in the temperature sensor 9, a simulation model calculates the degree to which the high-pressure discharge lamp has heated up due to the electrical power supplied so far. For example, the temperature sensor 9 may use a low-pass filter to calculate a smooth profile for the power values such as those reflected by the graph p(t). This smoothed profile approximates the profile of the temperature of the high-pressure discharge lamp sufficiently accurately.

To determine the temperature, the temperature sensor 9 may also take into account information on a rotational speed of a fan (not shown in FIG. 1) of the projector. It is also possible to measure the temperature of the lamp directly with a sensor.

The value determined by the temperature sensor 9 for the temperature is evaluated by a temperature monitoring unit 10. Depending upon the received value, the temperature monitoring unit 10 generates a correction value similar to that emitted by the integrator 6. The correction value of the temperature monitoring unit 10 is also offset against the nominal value 2 via the linking device 7.

However, if the value for the temperature lies between a permissible minimum value and a permissible maximum value, the temperature monitoring unit 10 emits a correction value, which has no influence on the power value 3. If, for example, the linking device 7 is an adder, the correct value can be the value zero.

If, during the operation, the temperature of the high-pressure discharge lamp drops below the minimum value or rises above the maximum value, the temperature monitoring unit 10 generates a correction value, which changes the power value 3 so that the lamp is not damaged.

In the case shown in FIG. 2, the power value 3 is reduced at a time point t₂′ by the temperature monitoring unit 10 when the temperature sensor 9 has recognized the risk of the lamp overheating. Accordingly, at the time point t₂′, the graph h(t) jumps to small values.

Immediately after the dropping of the power value 3 by the temperature monitoring unit 10 at the time point t₂′, the power value 3 is reduced still further by the correction value emitted by the integrator 6.

At the time point t₃, the scenes change again and a sequence of very dark images is started. Therefore, the power value 3 is reduced in accordance with the graph p(t). However, the rate limiter 5 prevents the power value 3 being reduced abruptly by such a large amount to such a low value as that specified by the nominal value 2 for the luminous intensity. Initially, at the time point t₃, the rate limiter 5 only permits a drop of the power value 3 by a similar amount as at the time point t₁. Then, the power value 3 is further reduced in a time interval between the time points t₃ and t₃′ according to a ramp function R. Overall, the rate limiter 5 ensures that the power value 3 does not drop too quickly to the value which it had at the time point t₃′. For a reduction by a change in the amount of the power ΔP from the value p(t₃) to the value p(t₃′), the rate limiter 5 specifies the duration Δt₃=t₃′−t₃ as the shortest time interval. As already described, the limitation of the rate of change of the supplied power represented by the graph p(t) prevents an increase in the voltage passing through the high-pressure discharge lamp voltage to above a maximal permissible ultra-high voltage.

The rate of change of the power value can be reduced by the rate limiter 5 in such a way that, for example, after a jump of the nominal value, the power value is tracked in steps or according to a ramp function.

From the time point t₃′, the influence of the integrator 6 outweighs the control of the power value 3. Accordingly, the graph p(t) again approaches the mean value line M.

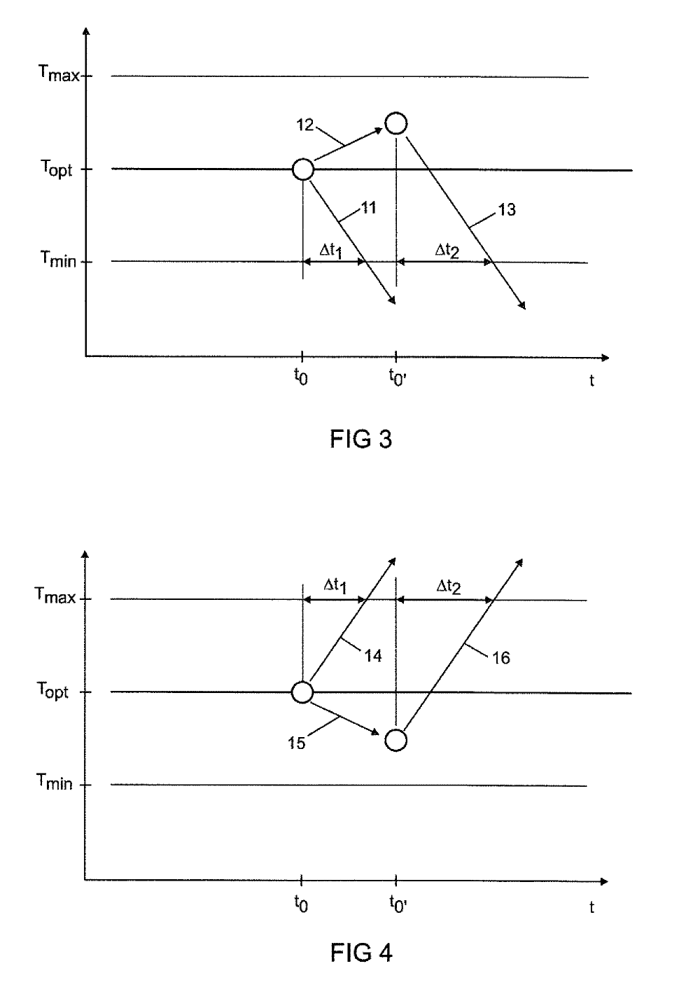

FIG. 3 shows two possible profiles of a temperature of a high-pressure discharge lamp a projector over the time t. Different temperature values are plotted along the ordinate. The two different profiles are obtained when the luminous intensity of the high-pressure discharge lamp is greatly reduced and the high-pressure discharge lamp is hereby either preheated according to the invention or this is not the case according to the prior art.

In this example, at a time point t₀ the high-pressure discharge lamp has an optimum operating temperature Tₒₚₜ. In FIG. 3, the temperature of the high-pressure discharge lamp is symbolized by a corresponding circle. In the example in FIG. 3, during operation, the temperature of the high-pressure discharge lamp has to lie between a minimum temperature Tₘᵢₙ and a maximum temperature Tₘₐₓ to ensure that the lamp is not damaged.

At the time point t₀, a nominal value for the luminous intensity of the high-pressure discharge lamp is transmitted to a control unit of the projector and this causes the lamp to be supplied with a relatively low electrical power. This results in a cooling-down of the lamp.

To this end, FIG. 3 shows two possible profiles of the temperature.

On the one hand, the case according to the prior art is depicted, according to which the nominal value transmitted at the time point t₀ controls an electrical power to be supplied at the same time point t₀. Therefore, the supplied electrical power is reduced immediately. This also causes the temperature of the lamp to drop immediately according to a profile depicted by an arrow 11. After a period Δt₁, the high-pressure discharge lamp is then cooled down to the minimum permissible minimum temperature Tₘᵢₙ so that protective action has to be taken. The impact of the protective action on the temperature is not shown in the diagram in FIG. 3.

In the second case, preheating of the lamp is possible in that the nominal value transmitted at the time point t₀ only controls electrical power to be supplied at a future time point t₀′. To this end, the nominal value is monitored by the control device.

For the case, in which the nominal value received at the time point t₀ controls the electrical power to be supplied immediately, the electrical power to be supplied at the time point t₀′ can, for example, be estimated by a statistical evaluation of the nominal values received at the time point t₀.

However, it can also be provided that the control device is designed in such a way that the nominal value received at the time point t₀ value relates from the start to the future time point t₀′.

Since, the control device recognizes at the time point t₀ that the power to be supplied at the future time point t₀′ is very low, the high-pressure discharge lamp is preheated. This initially results in a temperature profile as depicted by an arrow 12.

The preheating can be achieved by reducing a cooling capacity of a cooling unit of the projector. For example, a rotational speed of a fan can be reduced. It is also possible for the luminous intensity of the lamp to be increased initially. This also causes an increase in the temperature of the lamp. Then, however, a display unit of the projector has to be adapted so that images projected between the time points t₀ and t₀′ do not become excessively bright.

At the time point t₀′, the power supplied is reduced in accordance with the nominal value received at the time point t₀. This causes the high-pressure discharge lamp to cool down. A resultant profile of the temperature is indicated in FIG. 3 by an arrow 13. After a period Δt₂, the high-pressure discharge lamp is then cooled down to the minimal permissible minimum temperature Tₘᵢₙ so that protective action has to be taken. As in the first case, the effect of the protective action on the temperature is not shown in the diagram in FIG. 3.

Due to the preheating, the period Δt₂ is longer than the period Δt₁. Therefore, it is achieved by means of the preheating that the luminous intensity of the high-pressure discharge lamp can be reduced for a longer period in accordance with the nominal value without having to take protective action. This makes it possible, even with dark images, to improve the contrast of a projection for a longer time by reducing the luminous intensity of the high-pressure discharge lamp.

FIG. 4 shows temperature profiles for the temperature of a high-pressure discharge lamp corresponding to those shown in FIG. 3. The temperature profiles in FIG. 4 result from a nominal value for a projection of an above-averagely bright image. The lamp is therefore supplied with a relatively high amount of electrical power resulting in an increase in the temperature of the lamp.

In the event that the nominal value transmitted at a time point t₀ controls the power to be supplied at present, there is an immediate increase in the temperature as indicated by the arrow 14. After a period Δt₁, the lamp is heated to a maximum temperature Tₘₐₓ.

In the case, that the nominal value present at the time point t₀ refers to a future time point t₀′, it is possible to cool down the high-pressure discharge lamp in the interim. Its temperature then initially has a profile as indicated by an arrow 15.

The precooling can be performed by measures corresponding to those explained in connection with FIG. 3.

Then, at the time point t₀′, the supplied electrical power is increased in accordance with the nominal value. As a result, there is an increase in the temperature of the high-pressure discharge lamp. The profile of the temperature is indicated by an arrow 16. After a period Δt2, the temperature has risen to the maximum temperature Tₘₐₓ.

The result of the precooling is that the period Δt₂ is longer than the period Δt₁. As in the case of preheating, which was described in connection with FIG. 3, the precooling of the high-pressure discharge lamp also makes it possible that the power can be supplied longer in the manner as specified by the nominal value.

Overall, the examples show how the invention enables the contrast of projected images to be improved. To this end, the temperature of the lamp is monitored and the luminous intensity of the lamp corrected if the temperature of the lamp leaves the permissible temperature range. In the case of a transition, for example from bright to dark image sequences, the contrast is initially improved in the desired way in that the luminous intensity of the lamp is reduced particularly significantly for a short time. Hereby, the reduction may be more pronounced than was previously possible with the prior art. The luminous intensity is then automatically increased again, which protects the lamp from cooling down. The particularly high-contrast transition is clearly perceived by an observer, while the subsequent increase in the luminous intensity is hardly perceived. The temperature of the lamp may also be actively influenced in advance if, for example, there is about to be a change from a bright image sequence to a dark image sequence. Pre-heating enables the lamp to be then operated for a longer period at less power since it takes longer to cool down to a critical minimum temperature. This makes it possible to reduce the luminous intensity of the lamp for a longer period.

1. A method for operating a projector having a high-pressure discharge lamp, wherein an intensity of a light emitted by the high-pressure discharge lamp depends upon an electrical power supplied to the high-pressure discharge lamp, comprising:
providing image information to be projected,
depending on the image information, determining a nominal value for the intensity of the light;
supplying electrical power to the high-pressure discharge lamp at least in dependence on the nominal value for the intensity,
determining a value correlated with a temperature of the high-pressure discharge lamp, and
supplying additional electrical power depending on the value for the temperature.

2. The method as claimed in claim 1, wherein more electrical power is supplied than obtained according to the nominal value for the intensity if the value for the temperature is lower than a prespecified minimum value.

3. The method as claimed in claim 1,
wherein the value for the temperature is calculated from power values each of which corresponds to an electrical power supplied to the high-pressure discharge lamp at a preceding point of time.

4. The method as claimed in claim 3,
wherein the value for the temperature is calculated from the power values by smoothing or by filtering with a low-pass filter (9).

5. The method as claimed in claim 1, wherein the amount of power supplied is changed within a prespecified period by a presettable value.

6. The method as claimed in claim 5,
wherein, at least for a part of the prespecified period, the changing is performed according to at least one of a ramp function or in a plurality of steps.

7. A method for operating a projector having a high-pressure discharge lamp, wherein an intensity of a light emitted by the high-pressure discharge lamp depends upon an electrical power supplied to the high-pressure discharge, comprising:
providing image information to be projected,
determining, depending on the image information, a nominal value for the intensity of the light
supplying electrical power to the high-pressure discharge lamp at least in dependence on the nominal value for the intensity,
wherein a mean value for an electrical power supplied to the high-pressure discharge lamp in a preceding time interval is calculated and, depending on the calculated mean value, the electrical power is additionally supplied in accordance with a controller for adjusting the mean value to a nominal mean value.

8. The method for operating a projector having a high-pressure discharge lamp, wherein an intensity of a light emitted by the high-pressure discharge lamp depends upon an electrical power supplied to the high-pressure discharge, comprising:
providing image information to be projected,
determining a nominal value for the intensity of the light depending on the image information,
supplying electrical power to the high-pressure discharge lamp at least in dependence on the nominal value for the intensity,
wherein a future nominal value for an intensity to be provided at a prespecified future time point (t₀′) intensity is determined and
prior to the future time point, a temperature of the high-pressure discharge lamp is changed in dependence on the future nominal value.

9. The method as claimed in claim 8,
wherein
a) the nominal value determined for the intensity is a future nominal value or
b) a future nominal value is estimated by means of a statistical evaluation of consecutive nominal values for the intensity.

10. The method as claimed in claim 8,
wherein the temperature is increased if the future nominal value falls below a presettable first threshold value, and/or the temperature is reduced if the future threshold value exceeds a presettable second threshold value.

11. The method as claimed in claim 8,
wherein, to change the temperature prior to the future time point, the high-pressure discharge lamp electrical power is additionally supplied in dependence on the future nominal value and wherein the light transmission or reflectance behavior of a transparent or reflecting display element of the projector, by means of which information can be displayed and which, for the projection of image information to be projected, is transilluminated or illuminated by the light of the high-pressure discharge lamp, is changed in dependence on the future nominal value.

12. The method as claimed in claim 8,
wherein, to change the temperature, a cooling capacity of a cooling device for the high-pressure discharge lamp is changed.

13. A projector having a high-pressure discharge lamp and a control unit,
configured to accept a nominal value for an intensity of a light emitted by the high-pressure discharge lamp and
to supply the high-pressure discharge lamp with electrical power at least in dependence on the nominal value,
wherein the control unit is configured
to determine a value corresponding to a temperature of the high-pressure discharge lamp and
to supply electrical power to the high-pressure discharge lamp depending on the value for the temperature.

14. The projector having a high-pressure discharge lamp and a control unit, configured
to accept a nominal value for an intensity of a light emitted by the high-pressure discharge lamp and
to supply electrical power to the high-pressure discharge lamp at least in dependence on the nominal value,
wherein the control unit is
further configured to calculate a mean value for an electrical power supplied to the high-pressure discharge lamp in a preceding time interval and
depending on the calculated mean value, to supply the electrical power in accordance with a controller for adjusting the mean value to a nominal mean value.

15. The projector having a high-pressure discharge lamp and a control unit,
configured to accept a nominal value for an intensity of a light emitted by the high-pressure discharge lamp and
to supply electrical power to the high-pressure discharge lamp at least in dependence on the nominal value,
wherein the control unit is additionally designed
to determine a future nominal value for an intensity to provide at a prespecified future time point and
prior to the future time point, to change a temperature of the high-pressure discharge lamp in dependence on the future nominal value.

16. The method as claimed in claim 1, wherein less electrical power is supplied than obtained according to the nominal value for the intensity if the value for the temperature is higher than a prespecified maximum value.
